(19) United States
(12) Patent Application Publication
(10) Pub. No.: US 2022/0351307 A1
(43) Pub. Date: Nov. 3, 2022

(54) METHOD AND DEVICE FOR MANAGING TEXTILE MACHINES, AND SYSTEMS EQUIPPED THEREWITH

(71) Applicant: TRÜTZSCHLER GMBH & CO. KG, Mönchengladbach (DE)

(72) Inventors: Armin LEDER, Mönchengladbach (DE); Peter VON DREUSCHE, Erkelenz (DE); Markus MOSEBACH, Krefeld (DE)

(73) Assignee: Trützschler Group SE, Mönchengladbach (DE)

(21) Appl. No.: 17/619,612

(22) PCT Filed: May 19, 2020
(86) PCT No.: PCT/EP2020/063946

§ 371 Date: Dec. 16, 2021

(30) Foreign Application Priority Data
Jun. 19, 2019 (DE) 10 2019 116 707.8

(51) Int. Cl. G06Q 50/04; G06Q 10/00; G05B 19/4155; D01H 13/32; D01G 15/76; D01G 31/00

(52) U.S. Cl. CPC G06Q 50/04; G06Q 10/20; G05B 19/4155; D01H 13/32; D01G 15/76; D01G 31/00; G06Q 30/0633

(57) ABSTRACT

A first computer-implemented method is disclosed for managing a textile machine comprises allowing to create, to select and/or to remove an object representing the textile machine, and t to add to the representing object, to modify and/or to remove spare parts therefrom and/or parts subject to wear, which belong to the textile machine. A second computer-implemented method is disclosed for managing a textile installation comprises allowing to create, to modify and/or to delete a textile installation with a plurality of textile machines and allowing to manage each one of the textile machines according to the first mentioned method. Another computer-implemented method is disclosed for managing an arrangement with a plurality of textile installations comprises allowing to create, to modify and/or to delete an assortment with a plurality of textile installations, and to manage each one of the textile installations according to the second mentioned method. A computer-readable medium comprises instructions executable by a processor for allowing a processor to perform one of the aforementioned methods.

### CROSS-REFERENCE TO RELATED APPLICATIONS

This application is a United States National Stage Application of International Application No. PCT/EP2020/063946 filed May 19, 2020, claiming priority from German Patent Application No. 10 2019 116 707.8 filed Jun. 19, 2019.

### BACKGROUND

The invention relates to a method and to a device for managing textile machines as well as installations equipped with such textile machines.

Such methods and devices are known per se. Generally, they are based on users being able to look into operating data and settings of textile machines and based thereon to estimate for example when the clothing for a carding drum needs to be exchanged. This is disadvantageous in that the order for potential parts subject to wear can be placed prematurely just based on practical knowledge, in order for the respective textile machine to be idle for the shortest possible time.

The EP 3 175 025 B1 discloses a method, in which sensor data, respectively status data of the textile machines are collected and correlated to a trend for the purpose of “predictive maintenance”. It is disadvantageous that solely operating status data of textile machines and data relating to the quality of a fibre band are used. This circumstance results in being able to detect only at a very late state, when a part needs to be maintained or exchanged.

### SUMMARY

An object of the invention is to address the foregoing disadvantages of the known prior art.

The above and other objects are an embodiment of the invention which provides for a computer-implemented method for managing a textile machine. The method comprises a first step of allowing to be able to create, to select and/or to remove an object representing the textile machine. This means, a user can freely set up the textile machine (potentially from a selection). Moreover, the method comprises a second step of allowing to be able to add to the representing object, to modify and/or to remove parts therefrom, belonging to the textile machine. This means, depending on the textile machine configuration a user can freely configure the textile machine. In this case, the term “part” relates to any type of part of the textile machine, which needs to be maintained and/or exchanged. Maintenance is understood to transfer the respective part again to a fully operational condition. Namely, the parts relate to spare parts, such a light-emitting means, parts subject to wear, such as clothings, or parts to be cleaned, such as measuring rolls.

Preferably, the first step includes a partial step of initially categorizing parts belonging to the textile machine. This means, the just created object is for example provided with standard parts. In case for example the manufacturer of the textile machine is known, a database can be queried, in which the standard parts are set up, which are delivered along with the purchase of the machine. This simplifies the operation.

In case of a respective part subject to wear, each associated data set can include additional information with regard to a current condition, an expected point in time of exchange and/or an expected point in time of maintenance of the respective part subject to wear. Said data can be provided by the manufacturer and/or entered by the user. Moreover, in said case, the method allows for entering the expected point in time of exchange, respectively of maintenance of the respective part subject to wear. As an alternative or in addition, automatically determining the expected point in time of exchange respectively of maintenance of the respective part subject to wear can be provided based on the influential data influencing the expected point in time of exchange, respectively of maintenance.

In the event the point in time of exchange, respectively of maintenance is automatically determined, the method can allow for entering and/or for selecting associated influential data. Consequently, the user can indicate, what influential data occur at the concerned textile machine.

In this case, influential data comprise:
information on the treated fibre material and an associated treatment duration,
data with regard to the first time of use of the respective part subject to wear,
predetermined periods of time, after the expiry thereof, a maintenance, respectively an exchange of the respective part subject to wear needs to take place, and/or
environmental conditions for the operation of the textile machine.

Consequently, these are data, which influence the lifetime of the respective part. In this case, lifetime is the span of time from the first time of use, respectively of maintenance up to the point in time of the next maintenance, respectively the exchange. Therefore, the user does not need to know how long a part is functional; just the production, respectively the data relating to the operation of the textile machine need to be entered. Therefore, also individuals can handle the method, who do not have any knowledge of the condition of the respective part.

Each one of the aforementioned methods can include signalizing an upcoming maintenance, respectively an upcoming exchange. Signalizing occurs, when falling short of a predetermined duration until reaching the next point in time of maintenance, respectively of exchange, in particular when it is down to 0. As an alternative or in addition, information is displayed relating to the respectively upcoming maintenance, respectively the upcoming exchange. Thereby, the user is informed at any time on the textile machine without being required to have any special knowledge.

Moreover, each one of the aforementioned methods can allow for:

ordering a respective spare part, respectively part subject to wear; and

automatically determine a compatible spare part, respectively part subject to wear and display for selection and/or manually enter and/or automatically determine suppliers for the respective spare part, respectively part subject to wear and to display and/or to manually enter.

Consequently, the user does not rely on the parts of the textile machine manufacturer. Products of third party manufacturers can be set up. In connection with the above-indicated first partial step, the initial specification of spare parts, respectively parts subject to wear can directly include the products of a third party manufacturer, in case they are not coming from the textile machine manufacturer.

Each one of the mentioned methods can provide for an authorization concept. Such concept includes a process of registering individuals in terms of predetermined rights for adding, modifying, respectively removing objects and/or information relating to spare parts, respectively parts subject to wear and potentially associated influential data. Thereby, a textile machine user can be prohibited for example from modifying spare parts. Thereby, the operational safety is increased, and errors can be reduced at least.

Each one of the mentioned methods can allow for creating a database with data belonging to the textile machine and for defining external access to the database. This means, all data belonging to the textile machine are centrally stored, for example in a cloud-based database and can be retrieved and used on suitable apparatuses. Thus, a universal use is possible.

Furthermore, the invention provides for a computer-implemented method for managing a textile installation. The method includes a first process step, which allows for being able to create, to modify and/or to delete a textile installation with a plurality of textile machines. Moreover, the method provides for a second process step, which allows for managing each one of the plurality of textile machines according to any of the aforementioned methods. This means in the simplest case, the user assorts the installation with the textile machines thereof, and once the initial assortment of the parts for each textile machine is given, the entire installation is pre-configured. This simplifies the operation considerably. In connection with the aforementioned authorization concept, a sort of administrator could pre-configure the installation, and the textile machine users just have access to the textile machine(s) they are managing.

In this case, the first process step can comprise a partial process step of initially categorizing textile machines belonging to the textile installation. This allows for being able to configure a type of standard installation, which serves as a template, when setting up a new installation, and thus provides a basic installation structure. Only adaptations need to be performed. This also serves the ease of operation and for preventing errors.

Furthermore, the invention provides for a computer-implemented method for managing an arrangement with several textile installations. Said method comprises a first configuration step, which allows for being able to create, to modify and/or to delete an assortment with several textile installations. In a second configuration step, managing each one of the several textile installations is allowed according to any of the associated aforementioned methods. This allows for making the invention employable for owners-operators of several installations, without experiencing any disadvantages.

In this case, the first configuration step can comprise a partial configuration step of initially categorizing textile installations belonging to the assortment. This allows for being able to configure a type of standard arrangement, which serves as a template when setting up a new arrangement and thus provides for a basic arrangement structure. Only adaptations need to be performed. This also serves the ease of operation and for preventing errors. Moreover, the invention provides for a computer-readable medium, which includes instructions executable by a processor for allowing a processor to perform a method according to any of the preceding claims. In addition to mobile storage, such as hard drives, the medium can also comprise data storage locations, such as the Cloud.

Finally, the invention relates to a device. The device comprises a processor. The processor is adapted to perform any of the aforementioned methods. Moreover, the device comprises an interaction device, embodied to accomplish an interaction with regard to the method steps with a user by means of the processor. In this case, this can be for example a server, a mobile apparatus, such as a mobile radiophone or else an operator terminal, for example at a textile machine.

### DESCRIPTION OF THE DRAWINGS

Further features and advantages of the invention will result from the following description of a preferred embodiment. It is shown in:

FIG. 1 display screen content for a method for managing a textile machine installation according to an embodiment of the invention,

FIG. 2 another display screen content for the method according to the embodiment of the invention,

FIG. 3 again another display screen content for the method according to the embodiment of the invention,

FIG. 4 display screen content similar to FIG. 2,

FIG. 5 display screen content with a production for different grinding intervals,

FIG. 6 display screen content with an indicated temporal planning with regard to maintenance, respectively exchange of units,

FIG. 7 display screen content for a PC-display screen for example for the method according to the embodiment of the invention in four details,

FIG. 8 display screen content in four details modified with regard to FIG. 7,

FIG. 9 display screen content in four details similar to FIG. 8, and

FIG. 10 a diagram of classes for the method according to the embodiment of the invention.

### DETAILED DESCRIPTION

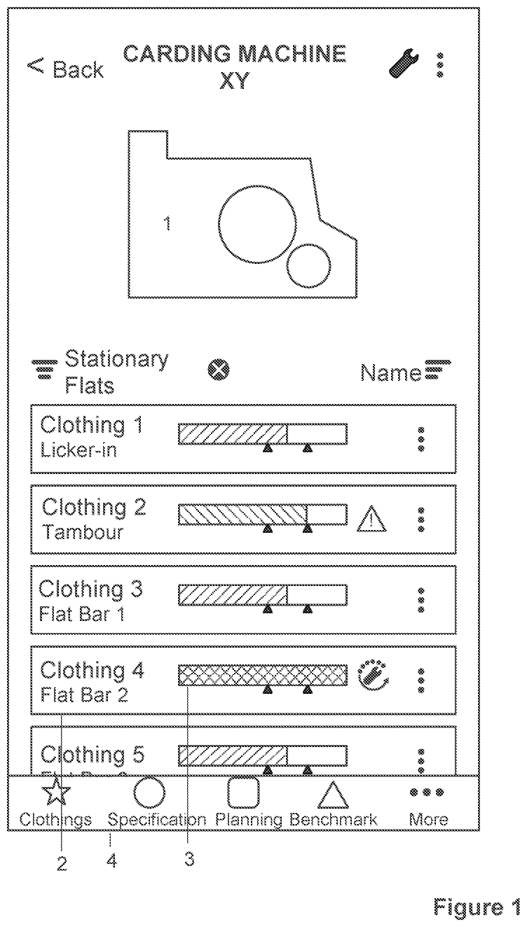

FIG. 1 shows display screen content for a method for managing a textile machine installation according to an embodiment of the invention,

In the top right area, there is a setting button for the herein symbolically illustrated carding machine 1. Thereunder, different clothings are displayed in terms of the specification 2 thereof, for example for the tambour, the conditions thereof being illustrated in terms of maintenance and exchange. In this case, the respectively disposed triangles represent grinding points in relation to the operation progress. This means, once said points are reached, the associated clothing requires grinding. According to said illustration, however, the fourth clothing requires exchange, as can be seen by means of the bar in full length. In the lower area, the possibility is given, to modify the clothings, to modify the specifications thereof, for example in case the manufacturer changes, to set up, or to modify a timetable, when certain work is to be performed, and analyses. Other options and menu points can be included under the menu point “more”.

For accessing this display, clothing data with the points in time thereof for maintenance and exchange are stored preferably in a cloud-based storage. The clothings can be completely manufacturer-independent.

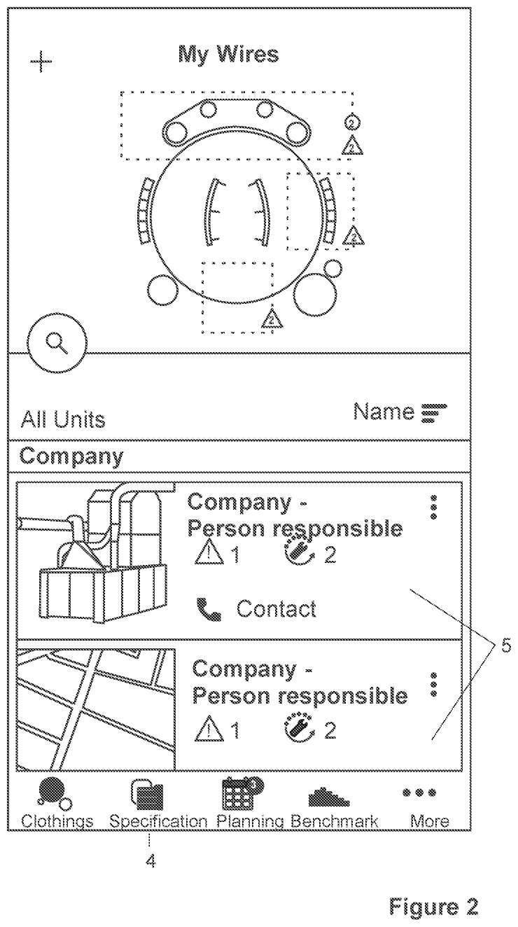

FIG. 2 shows a different display screen content for the method. In the upper area, now the respective textile machine is illustrated within the scope of the functional elements thereof. As can be seen, the flat bar is visually highlighted.

Thereunder are located two areas 5 with contact data, by way of example for the responsible employee and for the contact person as well as the address. Again, menu points 4 are located thereunder, in this case, for clothings, specifications, temporal planning and analyses, as well as material.

This means, the inventive method, which may also encompass managing of contact data, allows for establishing contact, identified by means of the telephone receiver.

Furthermore, the method can be employed for representing product novelties for customers.

Moreover, it is possible to start market analyses and to provide the customers with suggestions for grinding and the exchange. In this case, via a specific menu point, the user itself can determine grinding intervals and points in time for exchange, or if provided, can automatically have the program determine them, whereby preferably the required data therefore are stored in the cloud. Moreover, the user can activate a notification function such that current necessary, respectively upcoming work, such as passing orders, are displayed and/or signalled. For being notified about orders, the user can input for example periods of times, which prior to the respective exchange cannot be exceeded.

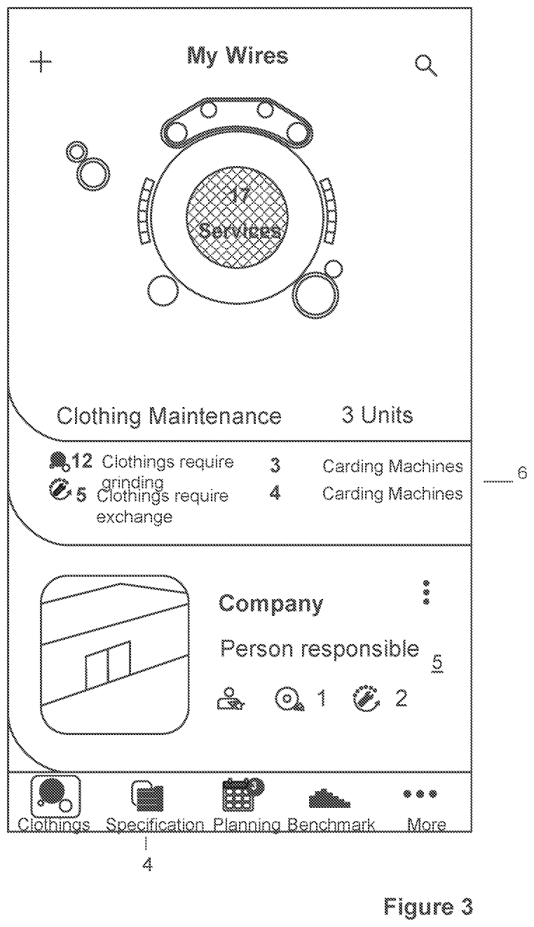

FIG. 3 shows display screen content, again relating to a carding machine, in which maintenance work is listed in an area 6. Furthermore, it can be seen herein that several carding machines are managed. Again, a contact area 4 is illustrated in the lower area.

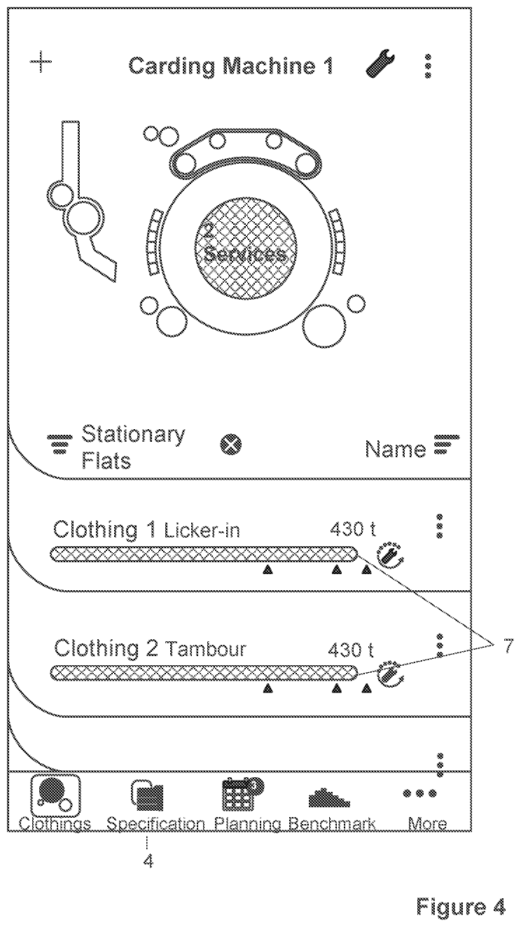

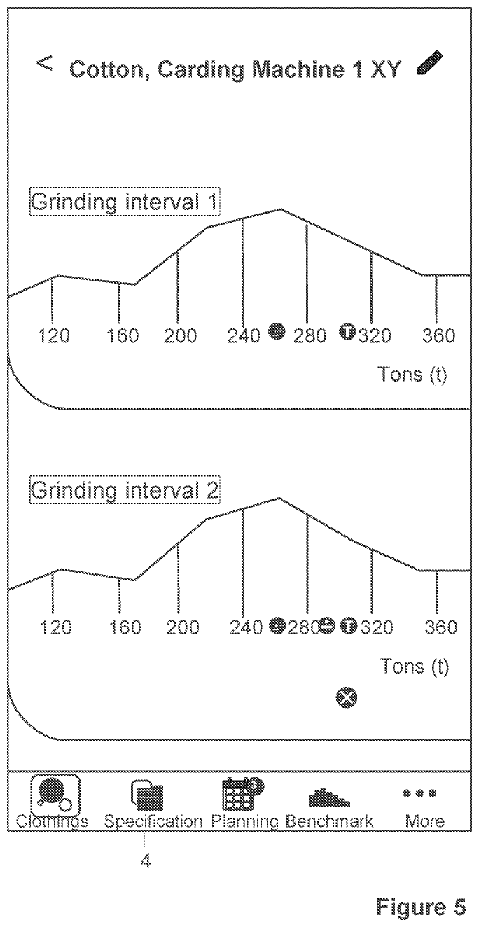

FIG. 4 shows display screen content similar to FIG. 2. However, herein there are respectively three triangles, wherein the third triangle identifies the point in time for exchanging the respective clothing. Furthermore, at the top in the centre, it can be seen that the carding machine and the visually highlighted flat bar already had two services performed. In this case, the bars 7 identify the progress of the respective clothing in terms of maintenance and exchange.

FIG. 5 shows display screen content with the production for different grinding intervals, i.e., periods of time until the first grinding happened, respectively between two grinding procedures, so the user can see, whether or not the production deteriorated for example.

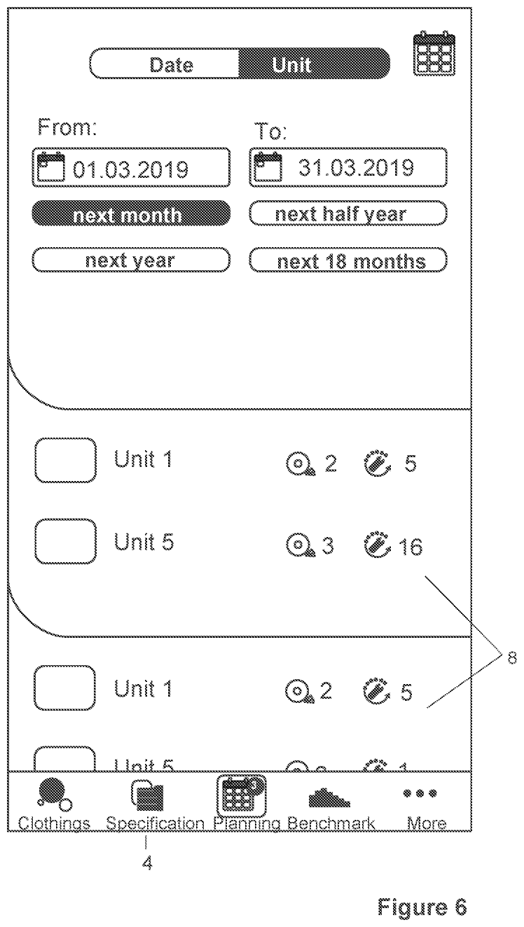

FIG. 6 shows display screen content indicating the temporal planning of the maintenance action(s), respectively exchanges of units, herein in two areas 8, by way of example in the shape of clothings. In the upper area, the display can be modified in the areas 8.

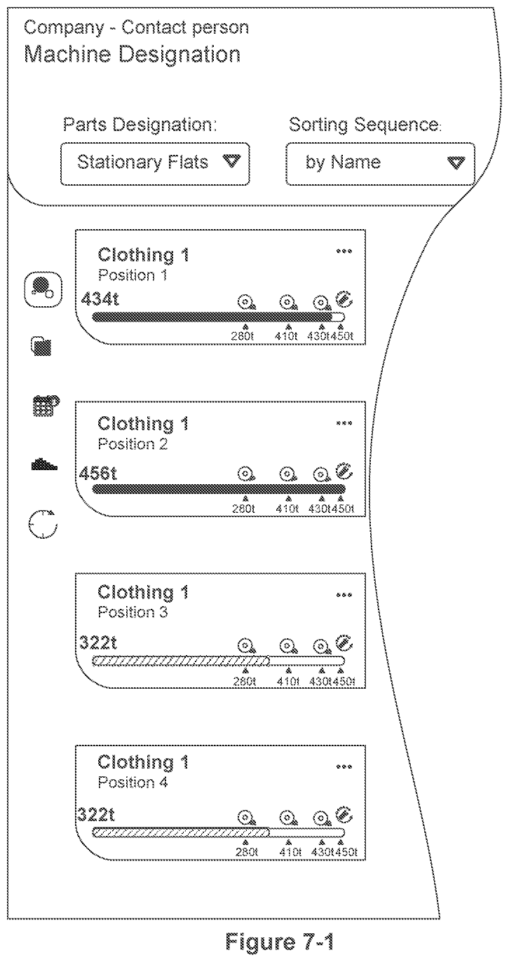

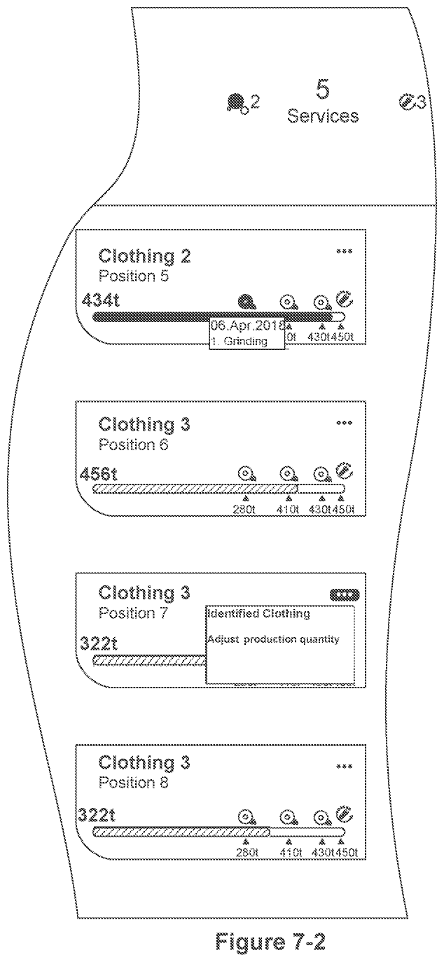

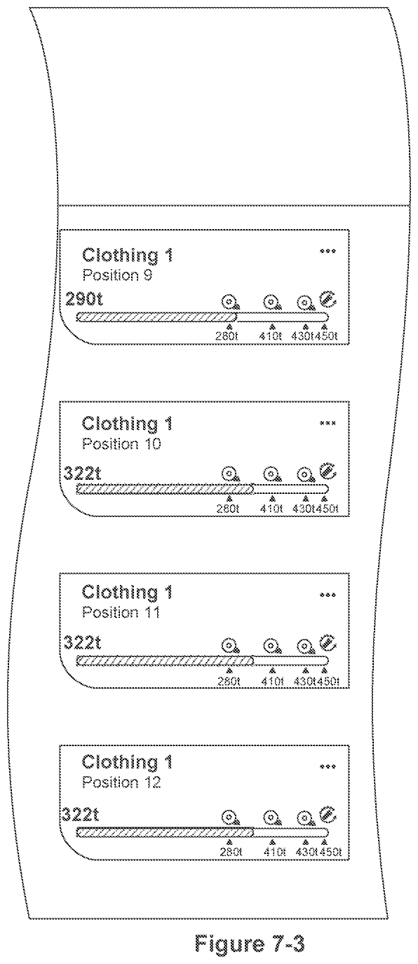

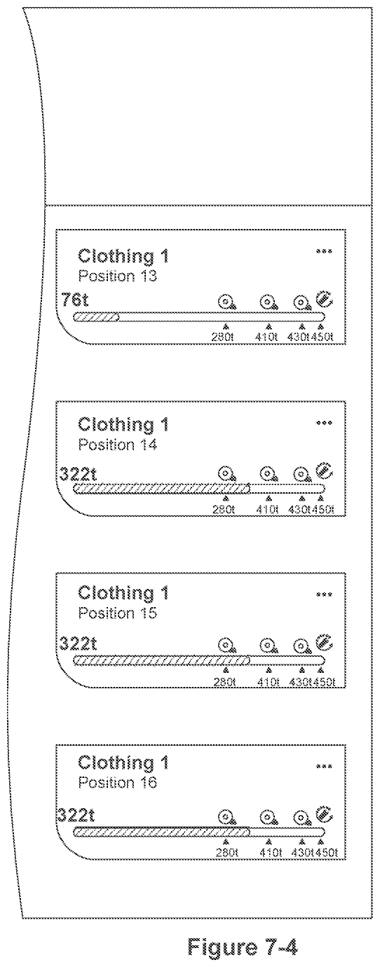

FIG. 7 shows display screen content for example for a PC display screen, which allows for representing several of the displays according to the FIGS. 2 to 6. In this case, FIG. 7 is subdivided into four partial Figures, which, in the order FIG. 7-1 to FIG. 7-4 horizontally from the left to the right hand side placed next to each other, result in the entire display screen content. Herein again, a carding machine is concerned, wherein already 5 services have been performed. In the illustration shown, the display contains several display screen contents according to FIG. 4.

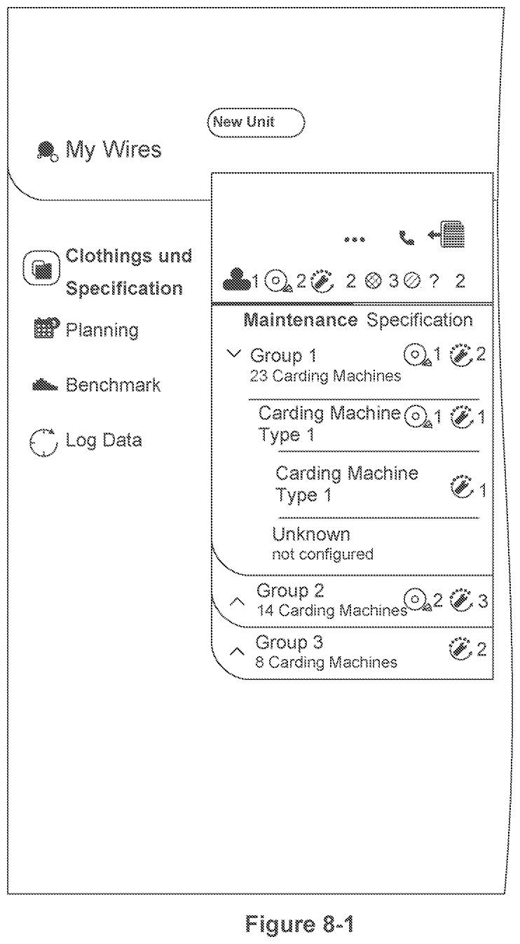

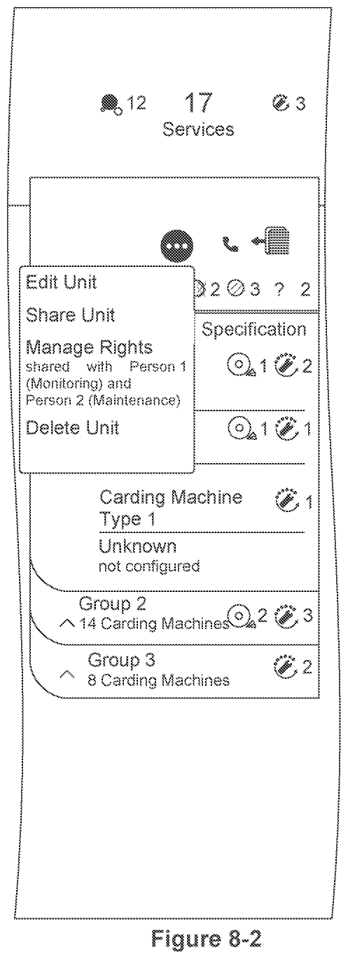

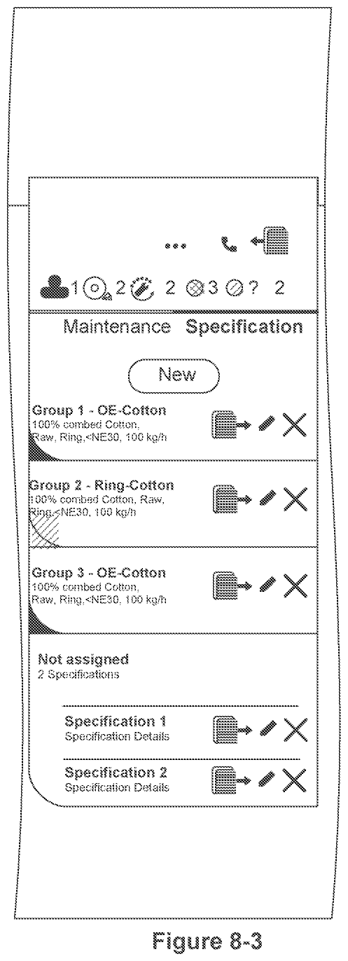

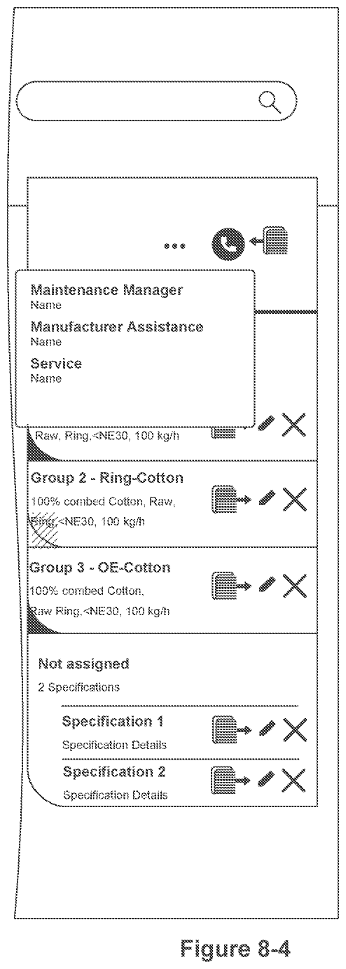

FIG. 8 shows again display screen content, for example for a PC display screen. Analogously to FIG. 7, FIG. 8 as well is subdivided into four partial Figures, which in the order FIG. 8-1 to FIG. 8-4 horizontally from the left to the right hand side placed next to each other result in the entire display screen content. Herein, the groups of textile machines (herein: carding machines) are illustrated grouped to textile machine installations. Moreover, under the menu point “specification”, it can be seen, which textile machine (at this moment) treats what kind of material. Moreover, the number of maintenance actions and adjusting work can be seen in the upper area and for each group and textile machine.

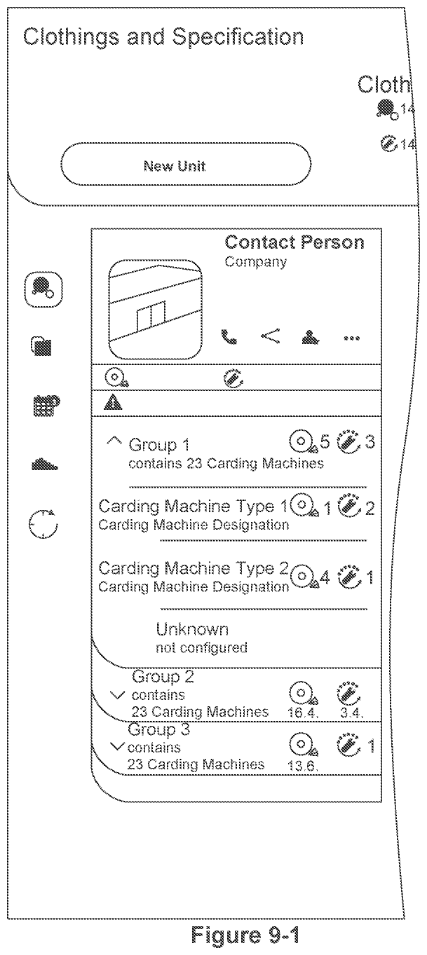

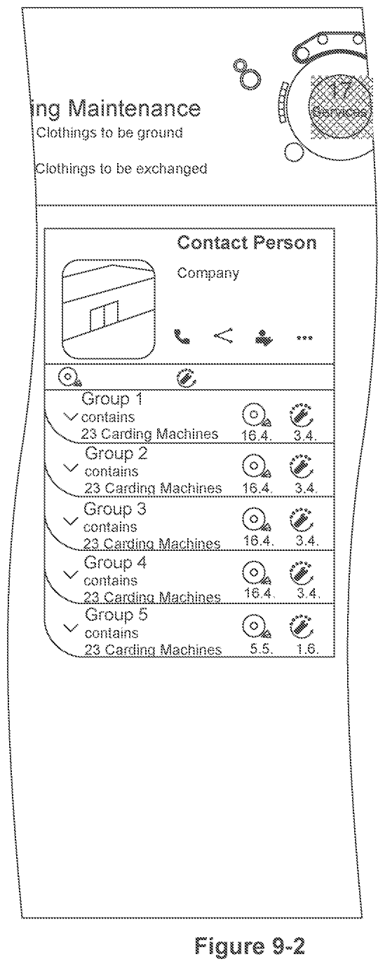

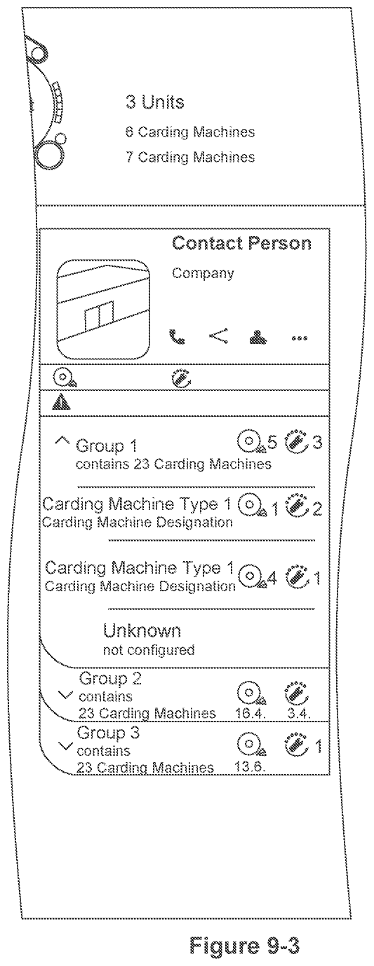

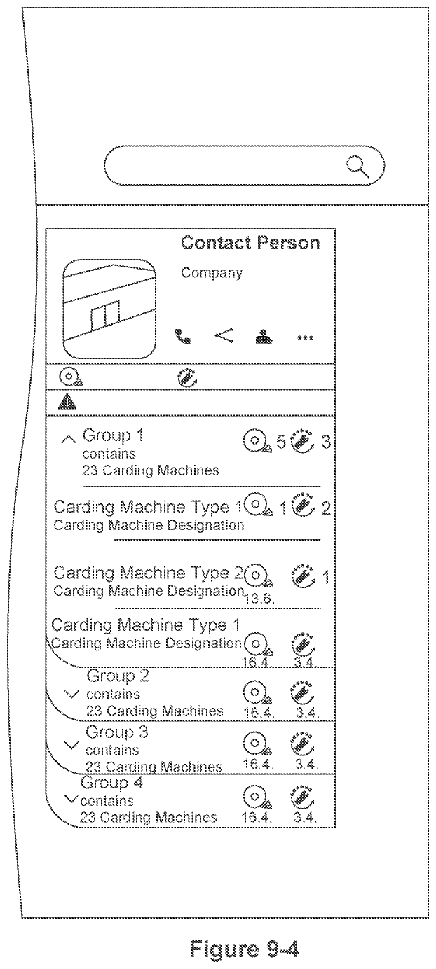

FIG. 9 shows display screen content similar to FIG. 8. Analogously to FIG. 7, respectively FIG. 8, FIG. 9 as well is subdivided into four partial Figures, which in the order FIG. 9-1 to FIG. 9-4 horizontally from the left to the right hand side placed next to each other result in the entire display screen content.

Additionally, there is one contact area 5 per group assortment (=arrangement of textile machine installations).

The respective group can be configured under the point “edit unit”.

User rights can be assigned, deleted and modified under the menu point “manage rights”.

Finally, the respective unit can be deleted.

Production parameters, for example treated fibre material, for the groups are indicated under the point “specification”,

In this case, there is “maintenance management”, “manufacturer assistance” and “service”. The respective contact, as a name, is illustrated under said points. Next to the name, also other data, such as for example telephone numbers, can be displayed, so as to be able to directly establish contact to the respective individual.

The inventive method allows for automatically tracking the production of a carding machine, for example. This can be realized by timing the duration, within which the carding machine (has) treated a certain fibre material. For example, for a batch change, the user can modify the fibre material in the program and, for example, reset the time counter to zero. Then, the point in time, when the carding machine is stopped, would be automatically detected and for example concatenated to a data set with the currently input batch and production data. Said procedure allows for having manually input, respectively automatically determine the wear of the clothing during the treatment of the latest batch. As an alternative or in addition, a corresponding period of time is subtracted for the known remaining period of time until the next maintenance, respectively until the next exchange.

Thereby, the method is completely independent of the type of textile machine and the clothing manufacturer.

Based on manufacturer-related production data, when creating/setting-up/copying for example a carding machine, it can be automatically determined when the installed clothings require grinding or exchange. The manufacturer could input or have those values input into the system for example against payment. Thus preferably, the method provides for either the manufacturers of said parts and/or of textile machines, which said system manages, themselves being able to input and to modify the data, or the software provider assumes said work.

An ordering system, potentially with linked payment module could be incorporated such that the user would be able to order the respective clothing, when an upcoming exchange is recognized, and namely at a time way in advance of the actual exchange of the clothing in question. Thereby, the down time of the carding machine can be reduced to a minimum. Moreover, the user does not have to have any knowledge on what data are relevant for being able to determine when a clothing needs to be exchanged.

Thus, the system is always up to date and does not have to be constantly maintained or readjusted by a user. Said method is also suitable for service employees, who assume for example grinding a clothing. The service employee directly understands which clothing is installed, and whether it requires grinding or exchanging.

For example, product novelties can be transmitted via a wireless connection from the manufacturer to the system and, for example, displayed as a notification window via a notification function.

Preferably, the method is furthermore designed in that only certain individuals have authorized access. For example, it can be provided for only the software provider having administrator rights.

Moreover, the method can be expanded by product, respectively market analyses.

Also, the method can provide for being able to individually input suggestions. For example, it can be the supplier of a clothing indicates an interval of production of 5,000 m, however, the customer knows by experience that the exchange better be realized already after the production of 4,000 m.

Preferably, s/he can input said information so that the setting can be adopted for all future textile machines of the same kind. When creating a “new” textile machine of the same kind, exactly those values are adopted, instead of the data specified by the manufacturer.

The invention is not limited to the above-described embodiments.

Even though the invention is described with regard to a clothing as a part subject to wear, it is obvious that the invention can be applied to any type of part subject to wear, such as for example drive belts. Moreover, the invention can be applied to any other type of part to be maintained, such as measuring rolls of a drafting system that need to be cleaned from time to time.

Moreover, the invention is applicable to any kind of textile machine. These are in particular:

bale openers,
cleaners,
mixers,
drafting systems,
sliver lappers,
combing machines,
flyer spinning machines,
spinning machines,
cross-lappers,
needling machines,
dryers, and
roller cards.

In addition to the configuration of a single textile machine, moreover, the invention provides for being able to manage several textile machines within the scope of a textile machine installation.

Furthermore, the method is designed for only certain individuals having access and that preferably different user (groups) have different authorizations. For example, one user circle is allowed to configure only carding machines. Another user group could be allowed modifying influencing variables, etc.

The invention is expandable to the possibility of being able to manage several textile machine installations.

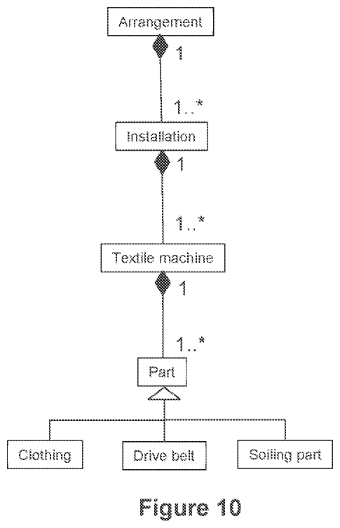

The hierarchically structured data model, the arrangement of textile machine installations, proper textile machine installations and textile machines, make the method highly scalable. All freedom to be able to modify, create and delete configurations is given. In case of an object-oriented approach, an exemplary constellation of classes could look like as illustrated in FIG. 10.

Managing an arrangement of textile machine installations is particularly interesting for owners-operators of spinning mills, which operate several spinning mill lines. In this case, each spinning mill line corresponds to one textile machine installation.

1. A computer-implemented method for managing a textile machine, including
a first step of allowing at least one of to create, to select and to remove an object representing the textile machine;
a second step of at least one of allowing to add, to modify and to remove parts from the object, which belong to the textile machine; and
in case of a respective part subject to wear
allowing for one of a) inputting an expected point in time of exchange or maintenance of the respective part subject to wear, and b) automatically determining the expected point in time of exchange or of maintenance of the respective part subject to wear based on influential data influencing the expected point in time of exchange or maintenance; and
at least one of c) signalling an imminent maintenance or an imminent exchange based on falling short of a predetermined period of time until reaching the expected point in time of maintenance or exchange, and d) displaying information relating to a respective one of the imminent maintenance and imminent exchange:
wherein the information includes at least one of a current condition, the expected point in time of exchange and the expected point in time of maintenance of the respective part subject to wear.

2. (canceled)

3. (canceled)

4. The method according to claim 1, wherein the allowing for the automatically determining the expected point in time of exchange or of maintenance of the respective part subject to wear includes allowing for at least one of inputting and selecting the influential data.

5. The method according to claim 4, wherein the influential data comprises at least one of:
information on a treated fibre material and an associated treatment duration;
data of a first time use of the respective part subject to wear;
predetermined periods of time, after expiry thereof, that one of maintenance and exchange of the respective part subject to wear needs to take place; and
environmental conditions for operation of the textile machine.

6. The method according to claim 1, wherein thy first step comprises a partial step of initially categorizing parts belonging to the textile machine.

7. The method according to claim 1, further including allowing for at least one of:
ordering a respective spare part or part subject to wear,
at least one of: 1) automatically determining and displaying for selection and 2) manually inputting, one of a compatible spare part and a part subject to wear; and
at least one of 3) automatically determining and displaying for selection and 4) manually inputting suppliers for a respective one of the spare part and the part subject to wear.

8. The method according to claim 1, further including registering individuals having predetermined rights for adding, modifying, and removing at least one of the objects, information relating to spare parts and parts subject to wear and associated influential data.

9. The method according to claim 1, further including a process of allowing for:
creating a database with data pertinent to the textile machine; and
defining external access to the database.

10. A computer-implemented method for managing a textile installation, including:
a third step of allowing at least one of to create, to modify and to delete a textile installation with a plurality of textile machines; and
a fourth process step of allowing to manage each one of the plurality of textile machines according to the method of claim 1.

11. The method according to claim 10, wherein the third process step comprises a partial process step of initially categorizing textile machines belonging to the textile installation.

12. A computer-implemented method for managing several textile installations, including:
a fifth step of allowing at least one of to create, to modify and to delete an assortment of a plurality of textile installations, and
a sixth step of allowing to manage each one of the plurality of textile installations according to the method of claim 10.

13. The method according to claim 12, wherein the fifth step comprises a partial configuration step of initially categorizing textile installations belonging to the assortment.

14. A computer-readable medium, which includes instructions executable by a processor for allowing a processor to perform a method according to claim 1.

15. A device, including
a processor adapted to perform the method according to claim 1, and
an interaction device embodied to accomplish with use of the processor an interaction with a user according to the method steps.
